(19) United States
(12) Patent Application Publication
(10) Pub. No.: US 2012/0220335 A1
(43) Pub. Date: Aug. 30, 2012

(54) WIRELESS TERMINAL DEVICE AND CONTROL METHOD

(75) Inventor: Daisuke Mori, Yokohama-shi (JP)

(73) Assignee: KYOCERA CORPORATION, Kyoto (JP)

(21) Appl. No.: 13/402,161

(22) Filed: Feb. 22, 2012

(30) Foreign Application Priority Data
Feb. 24, 2011 (JP) 2011-038512

(51) Int. Cl. H04W 88/02

(52) U.S. Cl. 455/552.1

(57) ABSTRACT

A cellular telephone device includes: a storage unit that stores LTE base station information regarding a base station, for which a location registration has been performed in an LTE system; a first transition processing unit, in which, in a case in which a communication request occurs in a 3G system while performing data communication in the LTE system, the first transition processing unit suspends the data communication in the LTE system, and performs transition to communication in the 3G system; and a second transition processing unit, in which, when the communication in the 3G system is completed, the second transition processing unit performs transition to communication in the LTE system, based on the LTE base station information stored in the storage unit.

This application is based on and claims the benefit of priority from Japanese Patent Application No. 2011-038512, filed on 24 Feb. 2011, the content of which is incorporated herein by reference.

### BACKGROUND OF THE INVENTION

1. Field of the Invention

The present invention relates to a wireless terminal device that performs wireless communication by selecting any one of a plurality of communication systems, and to a method of controlling such a wireless terminal device.

2. Related Art

In recent years, in addition to a 3G system of a CS (Circuit Switched) standard (for example, CDMA2000_{—}1× or W-CDMA) that is used for voice/data communication, an LTE system of an LTE (Long Term Evolution) standard, which is mainly used for high speed data transmission, has been introduced as a communication system utilized by a wireless terminal device such as a cellular telephone device.

In addition, a CS Fallback function is defined in 3GPP TS 23.272, and by way of this function, an incoming call request from the 3G system can be reported via the LTE system (for example, see 3GPP TS 23.272 V10.2.1, “Circuit Switched (CS) fallback in Evolved Packet System (EPS), Stage 2” 2011-01).

### SUMMARY OF THE INVENTION

An object of the present invention is to provide a wireless terminal device that can select an appropriate communication system, and a method of controlling such a wireless terminal device.

The wireless terminal device according to the present invention is a wireless terminal device that performs wireless communication by selecting any one of a plurality of communication systems, and the wireless terminal device includes: a storage unit that stores first base station information regarding a base station, for which a location registration has been performed in a first communication system; a first transition processing unit, in a case in which a communication request occurs in a second communication system while performing data communication in the first communication system, the first transition processing unit suspends data communication in the first communication system, and performs transition to communication in the second communication system; and a second transition processing unit, when the communication in the second communication system is completed, the second transition processing unit performs transition to communication in the first communication system, based on the first base station information stored in the storage unit.

Moreover, it is preferable for the first communication system to support a data communication, of which speed is higher than that of the second communication system; it is preferable for the second communication system to support voice communication in addition to data communication; and it is preferable for the communication request to be occurrence of an event of voice communication initiation.

In addition, it is preferable for the occurrence of the event to be occurrence of an incoming voice call for the device itself.

Furthermore, it is preferable for the first communication system to be of a CDMA standard, and the second communication system to be of an LTE standard: and it is preferable for CS-Fallback defined in 3GPP to be performed as a result of the occurrence of the incoming voice call.

Moreover, when transitioning to communication in the second communication system, it is preferable for the storage unit to further store second base station information regarding a base station, for which a location registration has been performed; and after completing the communication in the second communication system, when the data communication, which has been suspended in the first communication system, is resumed in the second communication system, in a case in which base station information as of the time of resuming the data communication coincides with the second base station information stored in the storage unit, it is preferable for the second transition processing unit to perform transition to communication in the first communication system, based on the first base station information stored in the storage unit.

In addition, when transitioning to communication in the second communication system, it is preferable for the storage unit to further store second base station information regarding a base station, for which a location registration has been performed; and after completing the communication in the second communication system, when the data communication, which has been suspended in the first communication system, is not resumed in the second communication system, and a predetermined period of time has elapsed, in a case in which base station information of a current base station, for which a location registration has been performed, coincides with the second base station information stored in the storage unit, it is preferable for the second transition processing unit to perform transition to communication in the first communication system, based on the first base station information stored in the storage unit.

Furthermore, each time a location registration is performed in the first communication system, it is preferable for the storage unit to store, as the first base station information, latest base station information of a base station, for which the location registration has been performed.

The control method according to the present invention is a control method for a wireless terminal device that performs wireless communication by selecting any one of a plurality of communication systems, and the control method includes: a storing step of storing first base station information regarding a base station, for which a location registration has been performed in a first communication system; a first transition processing step, in a case in which a communication request occurs in a second communication system while performing data communication in the first communication system, data communication in the first communication system is suspended to transition to communication in the second communication system; and a second transition processing step, when the communication in the second communication system is completed, the communication transitions to communication in the first communication system, based on the first base station information stored in the storing step.

The control method according to the present invention is a control method for a wireless terminal device that performs wireless communication by selecting any one of a plurality of communication systems, and the control method includes: a first transition processing step, in a case in which a communication request occurs in a second communication system while performing data communication in a first communication system, data communication in the first communication system is suspended to transition to communication in the second communication system; and a second transition processing step, when the communication in the second communication system is completed, the communication transitions to communication in the first communication system.

According to the present invention, the wireless terminal device can select an appropriate communication system.

### BRIEF DESCRIPTION OF THE DRAWINGS

FIG. 1 is a perspective view showing an appearance of a cellular telephone device according to an embodiment of the present invention;

FIG. 2 is a block diagram showing functions of the cellular telephone device according to the embodiment of the present invention;

FIG. 3 is a diagram showing procedures of a coordinated location registration according to the embodiment of the present invention;

FIG. 4 is a diagram showing an aspect of switching networks from an LTE system to a 3G system, according to the embodiment of the present invention; and

FIG. 5 is a flowchart showing processing in a control unit according to the embodiment of the present invention.

### DETAILED DESCRIPTION OF THE INVENTION

Descriptions are provided hereinafter regarding an example of a preferred embodiment of the present invention. It should be noted that, in the present embodiment, a cellular telephone device 1 is described as an example of a wireless terminal device.

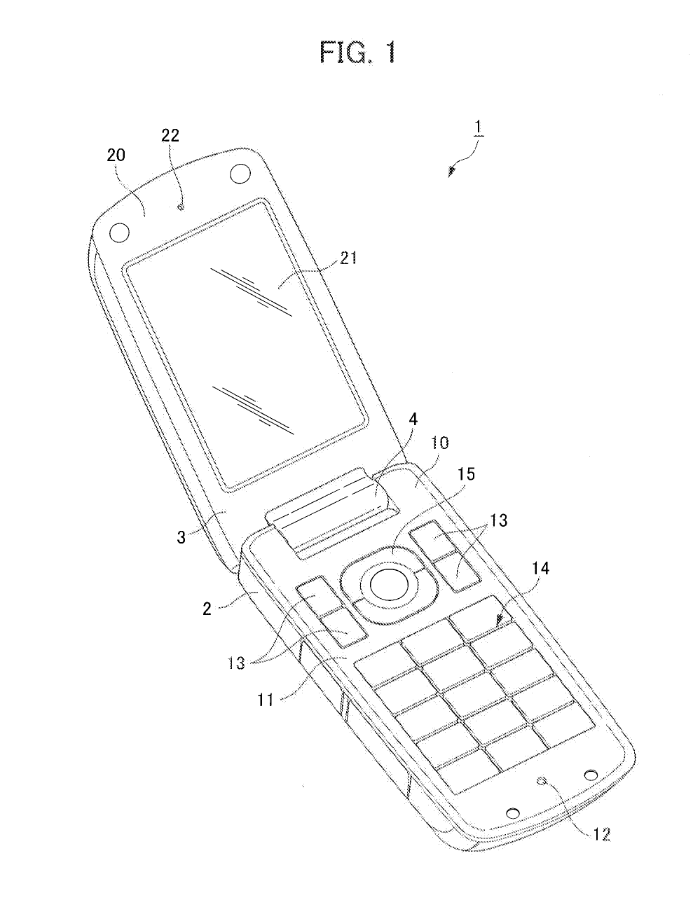

FIG. 1 is a perspective view showing an appearance of the cellular telephone device 1 according to the present embodiment.

It should be noted that, although FIG. 1 shows a so-called folder-type cellular telephone device, the cellular telephone device according to the present invention is not limited thereto. For example, the cellular telephone device may be of: a slider type in which one of the bodies slides to one direction in a state in which the bodies are mutually superimposed; a rotating (turning) type in which one of the bodies is rotated around an axis line along the direction of superimposing the bodies; and a type (straight type) in which an operation unit and a display unit are disposed in one body without having a connecting portion.

The cellular telephone device 1 is configured to include an operation unit side body 2 and a display unit side body 3. The operation unit side body 2 is configured to include, on a front face portion 10 thereof, an operation unit 11 and a microphone 12 to which sound produced by a user of the cellular telephone device 1 is input when the user is making a phone call or using a speech recognition application. The operation unit 11 is configured with: function setting operation buttons 13 for operating various functions such as for various setting functions, a telephone number directory function and a mail function; input operation buttons 14 for inputting the digits of a telephone number and characters for mail, etc.; and a selection operation button 15 for performing selection of various operations, scrolling, etc.

Moreover, the display unit side body 3 is configured to include, on a front face portion 20, a display unit 21 for displaying a variety of information, and a receiver 22 for outputting sound of the other party of the conversation.

In addition, an upper end portion of the operation unit side body 2 and a lower end portion of the display unit side body 3 are connected via a hinge mechanism 4. Furthermore, the cellular telephone device 1 can be arranged into a state where the operation unit side body 2 and the display unit side body 3 are apart from each other (opened state), and into a state where the operation unit side body 2 and the display unit side body 3 are contacting each other (closed state), by relatively rotating the operation unit side body 2 and the display unit side body 3, which are connected via the hinge mechanism 4.

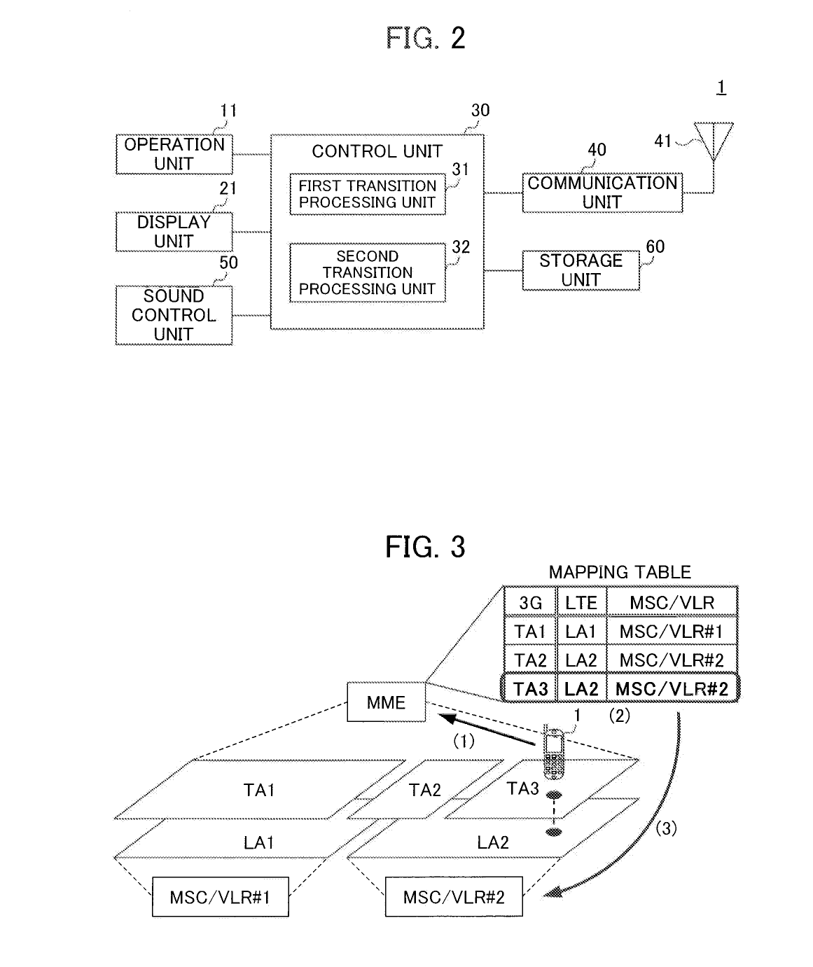

FIG. 2 is a block diagram showing functions of the cellular telephone device 1 according to the present embodiment.

The cellular telephone device 1 includes the operation unit 11, the display unit 21, a control unit 30, a communication unit 40, a sound control unit 50, and a storage unit 60.

The control unit 30 controls the entirety of the cellular telephone device 1, and performs, for example, predetermined control of each unit such as the display unit 21 and the communication unit 40. Moreover, the control unit 30 accepts input from the operation unit 11, the communication unit 40, etc. to perform a variety of processing. In addition, when executing such processing, the control unit 30 controls the storage unit 60 to read various programs and data and write data. It should be noted that detailed functions of the control unit 30 according to the present embodiment will be described later.

The communication unit 40 communicates with external devices (base stations) at a predetermined usable frequency band (for example, 2 GHz band, 800 MHz band, and the like). Furthermore, the communication unit 40 performs demodulation processing on a signal received via an antenna 41 and provides the signal thus processed to the control unit 30, and in addition, performs modulation processing on a signal provided from the control unit 30 and transmits the signal to an external device via the antenna 41.

Here, in the present embodiment, the communication unit 40 conforms to both a 3G standard such as a W-CDMA or CDMA2000_{—}1× standard that is a communication protocol for audio and data communication, and an LTE standard that is a communication protocol mainly used for high speed data transmission; therefore, the communication unit 40 can perform communication in a communication system of either protocol. Based on an instruction from the control unit 30, the communication unit 40 communicates with a base station through any of the protocols. It should be noted that the cellular telephone device 1 shall perform communication preferentially through an LTE system (a first communication system) by way of the LTE standard when performing data communication, and shall switch to a 3G system (a second communication system) by way of the 3G standard when performing a voice call.

In accordance with control by the control unit 30, the sound control unit 50 performs predetermined sound processing on a signal transmitted from the communication unit 40, and outputs the signal thus processed to the receiver 22. The receiver 22 externally outputs the signal transmitted from the sound control unit 50. It should be noted that the signal may be output from a speaker (not illustrated) in place of the receiver 22 or in addition to the receiver 22. Moreover, in accordance with control by the control unit 30, the sound control unit 50 processes a signal, which is input from the microphone 12, and outputs the signal thus processed to the communication unit 40. The communication unit 40 performs predetermined processing on the signal transmitted from the sound control unit 50, and outputs the signal thus processed from the antenna.

The storage unit 60 includes, for example, working memory, and is utilized for arithmetic processing by the control unit 30. In addition, the storage unit 60 stores various programs and the like according to the present embodiment.

Furthermore, the storage unit 60 stores LTE base station information (first base station information) regarding a base station, for which a location registration has been performed in the LTE system. More specifically, each time a location registration is performed in the LTE system, the storage unit 60 may store the latest base station information of a base station, for which the location registration has been performed. Moreover, when the communication in the LTE system transitions to the communication in the 3G system, the storage unit 60 further stores 3G base station information (second base station information) regarding a base station, for which the location registration has been performed, by associating the 3G base station information with the LTE base station information.

Here, the LTE base station information includes system information (a band class, a frequency channel, carrier identification information and the like), location registration information, IP address information and the like, which are broadcasted from the base station. In addition, the 3G base station information is obtained from a system parameter message that is broadcasted from the base station.

Next, detailed descriptions are provided for functions of the control unit 30.

The control unit 30 of the cellular telephone device 1 and a control unit of each communication system have a CS-Fallback function, with which incoming communication from the 3G system is reported in the LTE system.

Here, in order to implement the CS-Fallback function, it is necessary to recognize in which calling zone in the 3G system the terminal on standby in the LTE system is physically located. Accordingly, an MME (Mobility Management Entity), which is a control unit of the LTE system, stores mapping data for indicating a corresponding relationship of physical calling zones that overlap between the LTE system and the 3G system.

In addition, when the control unit 30 of the cellular telephone device 1 performs a location registration request in the LTE system, the MME obtains, from the mapping data, a calling zone in the 3G system having an area overlapping with a calling zone in the LTE system, and performs a location registration request for this calling zone in the 3G system. When the 3G system receives the location registration request from the LTE system, the 3G system updates the location registration information, and returns a response to the LTE system. In this way, when a location registration of the cellular telephone device 1 is performed for a calling zone in the LTE system, the MME also performs a location registration (coordinated location registration) of the cellular telephone device 1 for a calling zone in the 3G system corresponding to the calling zone in the LTE system.

FIG. 3 is a diagram showing procedures of the coordinated location registration according to the present embodiment.

The MME, which is the control unit of the LTE system, manages three calling zones (TA1, TA2 and TA3). Moreover, an MSC (Mobile Switching Center)/VLR (Visited Location Register) #1 and an MSC/VLR #2, which are control units of the 3G system, manage calling zones LA1 and LA2, respectively.

In addition, the MME stores a corresponding relationship between TA1 and LA1, and a corresponding relationship between TA2/TA3 and LA2, as mapping data in a mapping table.

First of all, the control unit 30 of the cellular telephone device 1 located in the calling zone TA3 in the LTE system performs location registration processing for the MME (1). Based on the mapping table, the MME identifies the calling zone LA2 in the 3G system, in which the calling zone LA2 physically overlaps with the calling zone TA3 (2). In addition, the MME performs a location registration request for the MSC/VLR #2 that manages the calling zone LA2 (3). When receiving this request, the MSC/VLR #2 performs location registration processing, and stores information that the cellular telephone device 1 is located in the calling zone TA3 in the LTE system.

As a result of performing the coordinated location registration, incoming communication in the 3G system is reported to the MSC/VLR #2, and the MSC/VLR #2 further transmits an incoming communication report to the MME.

Furthermore, the control unit 30 includes a first transition processing unit 31 and a second transition processing unit 32, with which a communication system for performing communication is selected in accordance with a predetermined condition, thereby performing transition.

In a case in which a communication request occurs in the 3G system while performing data communication in the LTE system, the first transition processing unit 31 suspends the data communication in the LTE system, and performs transition to communication in the 3G system.

More specifically, for example, in a case in which an incoming communication report packet of the 3G system is received by way of the CS-Fallback function, the first transition processing unit 31 executes response processing by performing handover from the LTE system to the 3G system. Moreover, for example, in cases such as a case in which a “Phone to” function is used while browsing a web page through LTE communication, or a case in which an outgoing voice call is requested as multitask during the LTE communication, the first transition processing unit 31 suspends the data communication in the LTE system, and performs transition to outgoing voice call processing in the 3G system.

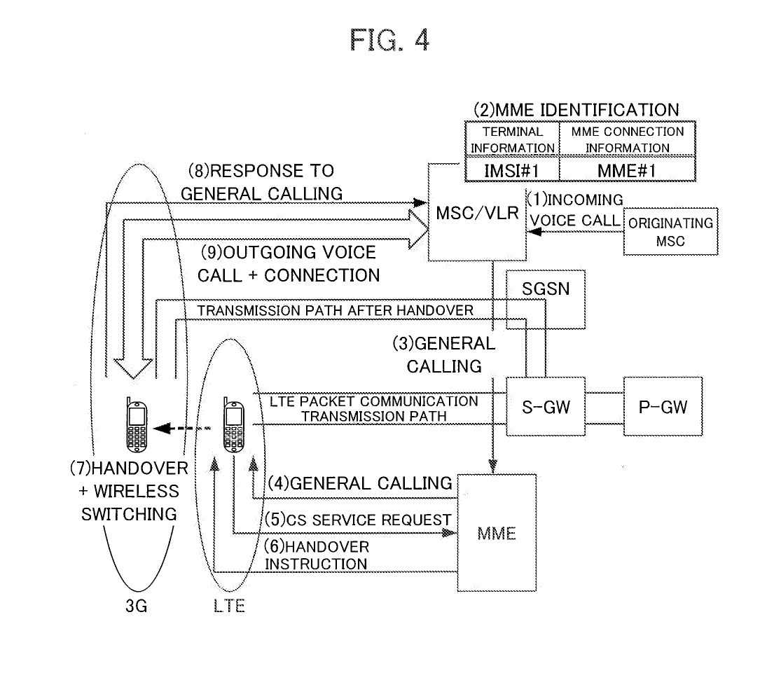

FIG. 4 is a diagram showing an aspect of switching networks from the LTE system to the 3G system, based on the CS-Fallback function according to the present embodiment.

When there is an incoming voice call from an originating MSC in the 3G system to the MSC/VLR in which the coordinated location registration of the cellular telephone device 1 has been performed (1), the MME in the corresponding LTE system is identified according to the stored location registration information of the cellular telephone device 1 (2), and the identified MME receives general calling (3).

The MME performs general calling of an incoming communication report to the cellular telephone device 1 (4), and when the MME receives a request for circuit switching services (5), the MME instructs the cellular telephone device 1 to perform handover to the 3G system (6 ).

Upon acquiring the 3G system, the cellular telephone device 1 performs handover from the LTE system to the 3G system (7), subsequently returns a response to the general calling to the MSC/VLR (8), and establishes connection of voice communication (9).

At this point in time, a packet communication transmission path from an S-GW (Serving Gateway) that is a packet switch of the LTE is switched to a network in the 3G system via an SGSN (Serving GPRS Support Node) that is a subscriber packet switch of the 3G.

When completing the communication in the 3G system, to which transition has been performed by way of the first transition processing unit 31, the second transition processing unit 32 acquires the LTE system, based on the LTE base station information stored in the storage unit 60, and performs transition to the communication in the LTE system.

More specifically, after completing the communication in the 3G system, when the data communication suspended in the LTE system is resumed in the 3G system, the second transition processing unit 32 obtains 3G base station information as of the time of resuming this data communication. In addition, in a case in which the obtained 3G base station information coincides with the 3G base station information as of the time of handover stored in the storage unit 60, the second transition processing unit 32 acquires the LTE system, based on the LTE base station information stored in the storage unit 60 in association therewith, and performs transition to communication in the LTE system.

Furthermore, when the data communication that was suspended in the LTE system is not resumed in the 3G system after completing the communication in the 3G system, and a predetermined period of time has elapsed, the second transition processing unit 32 obtains 3G base station information of a current base station, for which the location registration has been performed. In addition, in a case in which the obtained 3G base station information coincides with the 3G base station information as of the time of handover stored in the storage unit 60, the second transition processing unit 32 acquires the LTE system, based on the LTE base station information stored in the storage unit 60 in association therewith, and performs transition to communication in the LTE system.

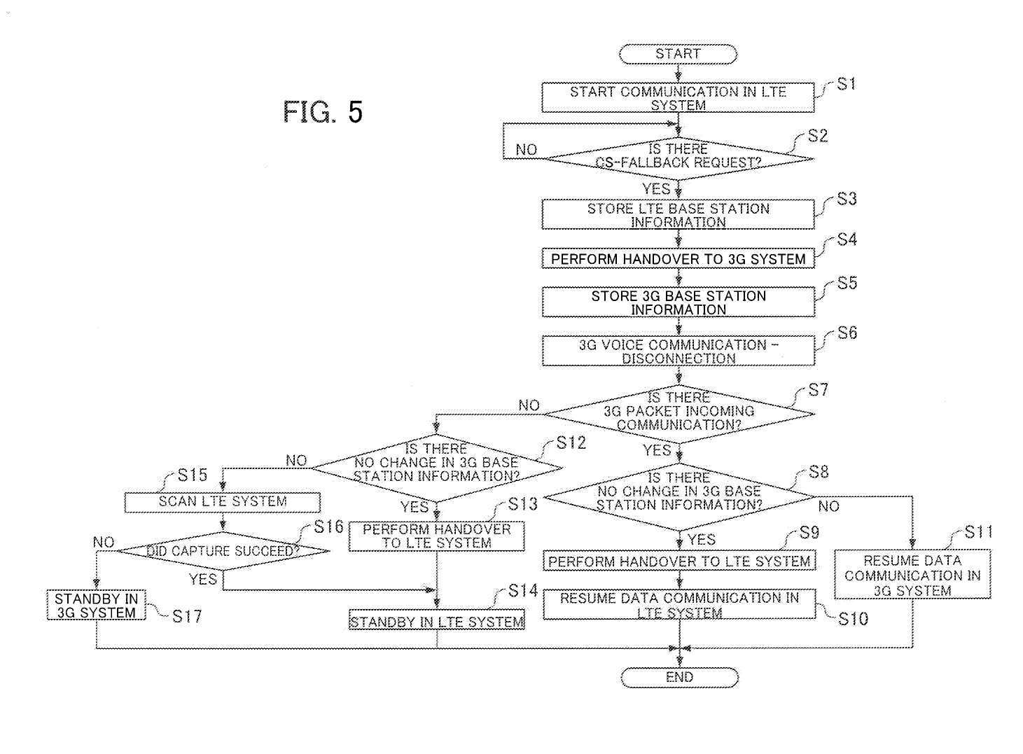

FIG. 5 is a flowchart showing processing in the control unit 30 of the cellular telephone device 1 according to the present embodiment.

In Step S1, in response to a request from a user or an application, the control unit 30 starts data communication in the LTE system.

In Step S2, upon receiving an incoming communication report by way of the CS-Fallback function, the control unit 30 determines whether handover to the 3G system was requested. In a case in which the determination is YES, the processing advances to Step S3, and in a case in which the determination is NO, the processing continues Step S2, and waits for an incoming communication report.

In Step S3, the control unit 30 obtains LTE base station information regarding a base station, for which the location registration has been performed, and stores the LTE base station information in the storage unit 60.

In Step S4, the control unit 30 suspends the data communication in the LTE system, and performs handover to the 3G system.

In Step S5, the control unit 30 obtains 3G base station information regarding a base station, for which the location registration has been performed, and stores the 3G base station information in the storage unit 60.

In Step S6, the control unit 30 starts voice communication in the 3G system, and when the voice communication is completed, the control unit 30 enters a standby state for communication in the 3G system.

In Step S7, the control unit 30 determines whether there is packet incoming communication for resuming the data communication in the 3G system, which was suspended in the LTE system. In a case in which the determination is YES, the processing advances to Step S8, and in a case in which the determination is NO, i.e. in a case in which there is no packet incoming communication, the processing advances to Step S12.

In Step S8, the control unit 30 determines whether there is no change in the 3G base station information from the time of performing handover to the 3G system. In a case in which the determination is YES, the processing advances to Step S9, and in a case in which the determination is NO, the processing advances to Step S11.

In Step S9, the control unit 30 performs handover to the LTE system, based on the LTE base station information stored in the storage unit 60 in association with the 3G base station information as of the time of handover.

In Step S10, the control unit 30 resumes the data communication, of which packet incoming communication was present in Step S7, in the LTE system.

In Step S11, since the control unit 30 cannot perform handover to the LTE system by using the LTE base station information stored in the storage unit 60, the control unit 30 resumes the data communication in the 3G system.

In Step S12, the control unit 30 determines whether there is no change in the 3G base station information from the time of performing handover to the 3G system, i.e. whether there is no significant movement (handover) in the 3G system. In a case in which the determination is YES, the processing advances to Step S13, and in a case in which the determination is NO, the processing advances to Step S15.

In Step S13, the control unit 30 performs handover to the LTE system, based on the LTE base station information stored in the storage unit 60 in association with the 3G base station information as of the time of handover.

In Step S14, the control unit 30 enters a communication standby state in the LTE system, in preparation for communication in the LTE system that is given priority over the 3G system.

In Step S15, the control unit 30 performs a scan (cell search) of the LTE system, in order to transition to the LTE system that is given priority over the 3G system.

In Step S16, the control unit 30 determines whether the LTE system was successfully captured. In a case in which the determination is YES, the processing advances to Step S14, and in a case in which the determination is NO, the processing advances to Step S17.

In Step S17, due to the failure in transitioning to the LTE system, the control unit 30 enters the communication standby state in the 3G system.

As described above, according to the present embodiment, by storing the LTE base station information, the cellular telephone device 1 can return to the LTE system after completing communication in the 3G system, in which the throughput of data communication in the LTE system is higher than that of the 3G system; therefore, an appropriate communication system can be selected.

At this point in time, the cellular telephone device 1 stores the latest LTE base station information, each time a location registration is performed in LTE system, i.e. each time transitioning is performed between base stations; therefore, the processing load when performing handover to the 3G system can be reduced.

Moreover, the cellular telephone device 1 stores 3G base station information when performing handover from the LTE system to the 3G system. Therefore, when completing communication (for example, voice communication) in the 3G system, the cellular telephone device 1 can efficiently return to the LTE system, based on the stored LTE base station information, on condition that the 3G base station information is not changed.

In addition, after performing handover to the 3G system by way of the CS-Fallback function during data communication in the LTE system, if transitioning between base stations was not performed, the cellular telephone device 1 can resume the suspended data communication in the LTE system; therefore, deterioration of throughput can be suppressed.

Furthermore, even in a case in which data communication is not resumed, if transitioning between base stations was not performed, the cellular telephone device 1 can return to the LTE system from the 3G system; therefore, an appropriate communication system can be selected in preparation for data communication to be performed thereafter.

Although an embodiment of the present invention has been described above, the present invention is not limited to the aforementioned embodiment. Moreover, the effects described in the embodiment of the present invention merely exemplify the most preferable effects arising from the present invention, and the effects according to the present invention are not limited to those described in the embodiment of the present invention.

The W-CDMA or CDMA2000_{—}1× standard and the LTE standard in the aforementioned embodiment are merely examples, and another communication protocol may be employed. In other words, one communication method may be a high speed communication method dedicated to data communication, and another communication method may be a communication method that supports both voice communication and data communication. For example, a GSM standard and a wireless LAN or the like may be similarly employed.

Moreover, the wireless terminal device according to the present invention is not limited to the cellular telephone device 1. The present invention can be applied to various devices such as a PHS (trademark: Personal Handyphone System), a PDA (Personal Digital Assistant), a gaming machine, a navigation device, a personal computer, a communication-dedicated module specialized in communication functions, and the like.

What is claimed is:

1. A wireless terminal device that performs wireless communication by selecting any one of a plurality of communication systems, the wireless terminal device comprising:
a storage unit that stores first base station information regarding a base station, for which a location registration has been performed in a first communication system;
a first transition processing unit, wherein, in a case in which a communication request occurs in a second communication system while performing data communication in the first communication system, the first transition processing unit suspends data communication in the first communication system, and performs transition to communication in the second communication system; and
a second transition processing unit, wherein, when the communication in the second communication system is completed, the second transition processing unit performs transition to communication in the first communication system, based on the first base station information stored in the storage unit.

2. The wireless terminal device according to claim 1,
wherein the first communication system supports a data communication, of which speed is higher than that of the second communication system,
wherein the second communication system supports voice communication in addition to data communication, and
wherein the communication request is occurrence of an event of voice communication initiation.

3. The wireless terminal device according to claim 2, wherein the occurrence of the event is occurrence of an incoming voice call for the device itself.

4. The wireless terminal device according to claim 3,
wherein the first communication system is of a CDMA standard, and the second communication system is of an LTE standard, and
wherein CS-Fallback defined in 3GPP is performed as a result of the occurrence of the incoming voice call.

5. The wireless terminal device according to claim 1,
wherein, when transitioning to communication in the second communication system, the storage unit further stores second base station information regarding a base station, for which a location registration has been performed, and
wherein, after completing the communication in the second communication system, when the data communication, which has been suspended in the first communication system, is resumed in the second communication system, in a case in which base station information as of the time of resuming the data communication coincides with the second base station information stored in the storage unit, the second transition processing unit performs transition to communication in the first communication system, based on the first base station information stored in the storage unit.

6. The wireless terminal device according to claim 1,
wherein, when transitioning to communication in the second communication system, the storage unit further stores second base station information regarding a base station, for which a location registration has been performed, and
wherein, after completing the communication in the second communication system, when the data communication, which has been suspended in the first communication system, is not resumed in the second communication system, and a predetermined period of time has elapsed, in a case in which base station information of a current base station, for which a location registration has been performed, coincides with the second base station information stored in the storage unit, the second transition processing unit performs transition to communication in the first communication system, based on the first base station information stored in the storage unit.

7. The wireless terminal device according to claim 1, wherein, each time a location registration is performed in the first communication system, the storage unit stores, as the first base station information, latest base station information of a base station, for which the location registration has been performed.

8. A control method for a wireless terminal device that performs wireless communication by selecting any one of a plurality of communication systems, the control method comprising:
a storing step of storing first base station information regarding a base station, for which a location registration has been performed in a first communication system;
a first transition processing step, wherein, in a case in which a communication request occurs in a second communication system while performing data communication in the first communication system, data communication in the first communication system is suspended to transition to communication in the second communication system; and
a second transition processing step, wherein, when the communication in the second communication system is completed, the communication transitions to communication in the first communication system, based on the first base station information stored in the storing step.

9. A control method for a wireless terminal device that performs wireless communication by selecting any one of a plurality of communication systems, the control method comprising:
a first transition processing step, wherein, in a case in which a communication request occurs in a second communication system while performing data communication in a first communication system, data communication in the first communication system is suspended to transition to communication in the second communication system; and
a second transition processing step, wherein, when the communication in the second communication system is completed, the communication transitions to communication in the first communication system.
